(19) United States
(12) Patent Application Publication
(10) Pub. No.: US 2008/0170202 A1
(43) Pub. Date: Jul. 17, 2008

(54) SAFETY LENS WITH A DIOPTRIC EFFECT

(76) Inventor: Min-Young Wang-Lee, Yung-Kang City (TW)

Correspondence Address: PAI PATENT & TRADEMARK LAW FIRM, 1001 FOURTH AVENUE, SUITE 3200, SEATTLE, WA, 98154, US

(21) Appl. No.: 11/623,082

(22) Filed: Jan. 14, 2007

(51) Int. Cl. G02C 7/06

(52) U.S. Cl. 351/168

(57) ABSTRACT

A safety lens has a protection panel and a dioptric component. The protection panel is transparent, flat and non-dioptric. The dioptric component is formed on the protection panel to provide a dioptric effect for a myopic or presbyopic wearer to allow the wearer to see through the dioptric component clearly. Therefore, the myopic or presbyopic wearer can see a workpiece through the dioptric component to perform detailed operations or through the protection panel to relax eyes when performing normal operations.

### BACKGROUND OF THE INVENTION

1. Field of the Invention

The present invention relates to a safety lens and more particular to the safety lens which has a dioptric effect and is adapted to a safety mask, a safety goggles or the like.

2. Description of Related Art

To protect eyes from being hurt by harsh lights or sparkles, users wear safety goggles when they perform welding, laser etching or other hazardous works.

With reference to FIG. 7, a conventional safety goggles (30) has a front, a mounting opening and a protection panel (31). The mounting opening is formed through the front of the safety goggles (30). The protection panel (31) is transparent, is flat and corresponds to and is mounted in the mounting opening of the safety goggles (30) to protect eyes of a user wearing the safety goggles from harsh lights and sparkles. However, the protection panel (31) does not provide any dioptric effect to a myopic or presbyopic wearer.

With reference to FIG. 8, a conventional dioptric safety lens in accordance with the prior art has a major lens (40) and two minor lenses (41). The major lens (40) is arcuate. The minor lenses (41) are formed symmetrically on the major lens (40), are dioptric and have a specific diopter value. Thus, a safety goggles equipped with the dioptric safety lens can provide a myopic or presbyopic wearer a clear sight.

However, because of the major lens (40) being arcuate, the major lens (40) is equivalent to a dioptric lens that has a certain diopter value different from the specific diopter value of the minor lenses (41). Thus, the different diopter values of the major lens (40) and the minor lenses (41) make the wearer have to frequently alternate his/her focus to prevent the wearer from easily and comfortably focusing in work and to cause the wearer giddy.

### SUMMARY OF THE INVENTION

The primary objective of the present invention is to provide a safety lens which provides a wearer a clear sight and makes the wearer easily and comfortably focus in work.

The safety lens comprises a protection panel and a dioptric component. The protection panel is transparent, is flat and is non-dioptric. The dioptric component is formed on the protection panel to provide a dioptric effect for a myopic or presbyopic wearer to allow the wearer to see through the dioptric component clearly when performing detailed operations. The wearer can also see the workpiece through the protection panel to relax eyes when performing normal operations, such that a giddy feeling caused by frequently alternating focus can be avoided.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a safety lens with a dioptric effect in accordance with the present invention;

FIG. 2 is a front view of the safety lens in FIG. 1;

FIG. 3 is a perspective view of a safety goggles with the safety lens in FIG. 1;

FIG. 4 is a side view in partial section of the safety goggles with the safety lens in FIG. 3;

FIG. 5 is a perspective view of a second embodiment of a safety lens with a dioptric effect in accordance with the present invention;

FIG. 6 is a perspective view of a third embodiment of a safety lens with a dioptric effect in accordance with the present invention;

FIG. 7 is a perspective view of a conventional safety goggles in accordance with the prior art; and

FIG. 8 is a perspective view of a conventional safety lens with a dioptric effect in accordance with the prior art.

### DETAILED DESCRIPTION OF THE PREFERRED EMBODIMENT

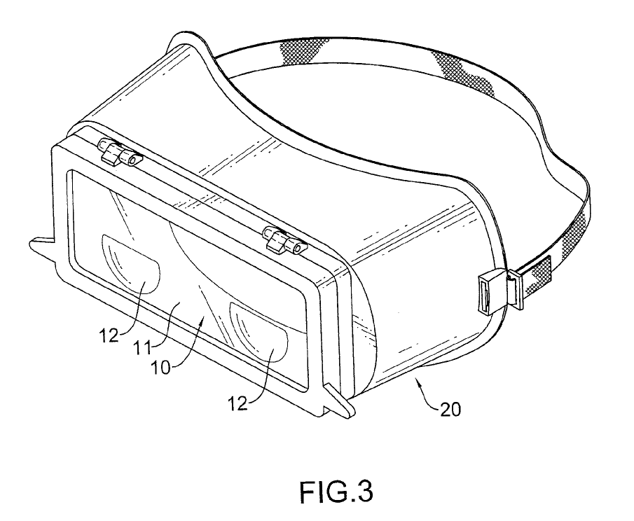

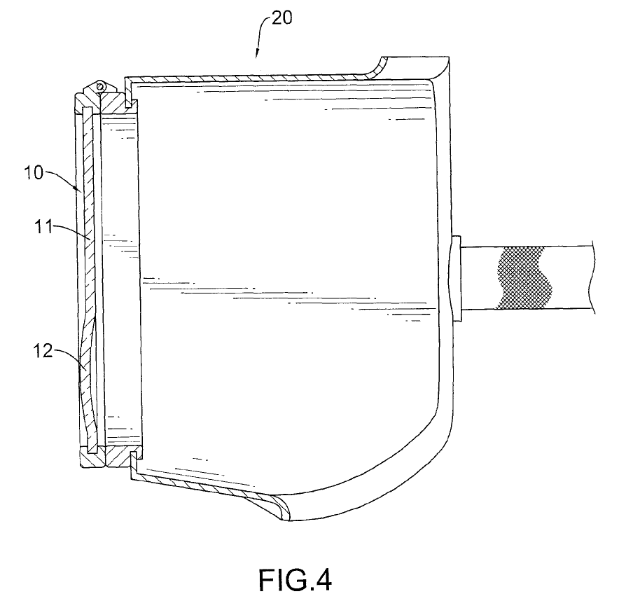

With reference to FIG. 3, a safety lens (10) in accordance with the present invention is mounted in a safety goggles (20) having a front and a mounting opening.

The mounting opening of the safety goggles (20) is formed through the front of the safety goggles (20).

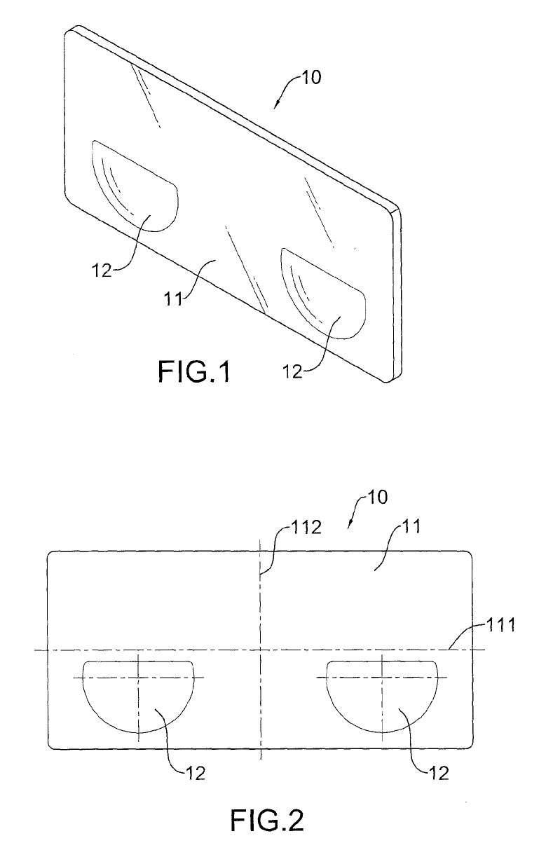

With further reference to FIGS. 1, 5 and 6, the safety lens (10) is an integral filter and corresponds to and is mounted in the mounting opening of the safety goggles (20) to protect a wearer's eyes from being hurt by sparkles and to filter harsh lights when the wearer performs hazardous works. The safety lens (10) has a protection panel (11) and a dioptric component.

The protection panel (11) is transparent, is flat and is non-dioptric to allow the wearer to directly see a workpiece when the wearer performs a work without detailed operations. The protection panel (11) has a middle section, a lower section, an imaginary longitudinal central line (112) and an imaginary horizontal central line (111) and may be rectangular. The imaginary longitudinal central line (112) has two sides. The imaginary horizontal central line (111) intersects the imaginary longitudinal central line (112) at a center of the protection panel (11) and is perpendicular to the imaginary longitudinal central line (112).

The dioptric component is formed on the protection panel (11) symmetrically to the imaginary longitudinal central line (112) to provide a dioptric effect for a myopic or presbyopic wearer, such that the wearer can see through the dioptric component clearly. The dioptric component may be implemented in several ways.

In a first embodiment of the dioptric component, the dioptric component is two minor lenses (12). The minor lenses (12) are dioptric, are formed symmetrically and integrally on the protection panel (11) and are located respectively on the two sides of the imaginary longitudinal central line (112) and may be located below the imaginary horizontal central line (111). Each of the minor lenses (12) has a specific diopter value, a front view and a top edge. With the specific diopter value, a myopic or presbyopic wearer can clearly see a workpiece through the minor lenses (12) to perform a work with many detailed operations. The wearer can also see the workpiece through the protection panel (11) by moving his/her eyes up when performing a normal work.

The front view of the minor lens (12) may be D-shape and be an analogue of a semicircular but large than the semicircular. The top edge of the minor lens (12) may be straight to form an obvious margin to avoid interfering the wearer's sight when the wearer sees through the protection panel (11).

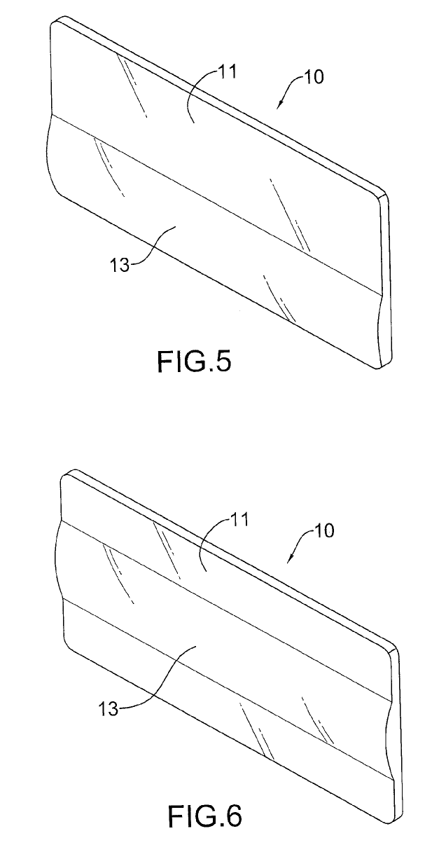

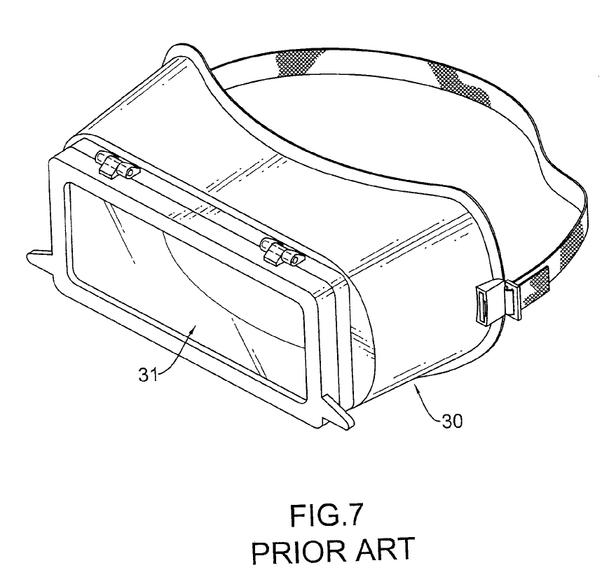

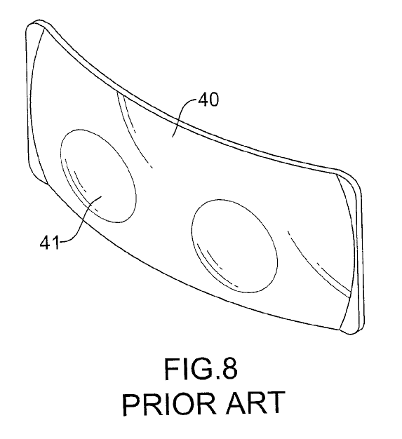

In a second embodiment of the dioptric component, the dioptric component is an elongated lens (13). The elongated lens (13) is dioptric, is formed symmetrically and integrally on the protection panel (11) and may be located on the middle section of the protection panel (11) (as shown in FIG. 6) or on the lower section of the protection panel (11) (as shown in FIG. 5) depending on a relative position between the protection panel (11) and the wearer's eyes.

The wearer can see the workpiece through the protection panel (11) until performing a detailed operation. Because the protection panel (11) is not dioptric, the wearer does not have to adjust his/her focus to see the workpiece during the period of a normal operation. Thus, the wearer can clearly see the workpiece and easily and comfortably focus during work time.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A safety lens being an integral filter and comprising:
a protection panel being transparent, flat and non-dioptric and having
a middle section;
a lower section;
an imaginary longitudinal central line having two sides; and
an imaginary horizontal central line intersecting the imaginary longitudinal central line at a center of the protection panel and being perpendicular to the imaginary longitudinal central line; and
a dioptric component formed on the protection panel symmetrically to the imaginary longitudinal central line.

2. The safety lens as claimed in claim 1, wherein the dioptric component is two minor lenses being dioptric, formed symmetrically and integrally on the protection panel, located respectively on the two sides of the imaginary longitudinal central line and each of the minor lenses having a diopter value.

3. The safety lens as claimed in claim 2, wherein the minor lenses are located below the imaginary horizontal central line.

4. The safety lens as claimed in claim 2, wherein each of the minor lenses further has
a front view being D-shape; and
a top edge being straight.

5. The safety lens as claimed in claim 1, wherein the protection panel is rectangular.

6. The safety lens as claimed in claim 1, wherein the dioptric component is an elongated lens being dioptric and formed symmetrically and integrally on the protection panel.

7. The safety lens as claimed in claim 6, wherein the elongated lens is located on the middle section of the protection panel.

8. The safety lens as claimed in claim 6, wherein the elongated lens is located on the lower section of the protection panel.
